(19) United States
(12) Patent Application Publication
(10) Pub. No.: US 2025/0336213 A1
(43) Pub. Date: Oct. 30, 2025

(54) INFORMATION PROCESSING DEVICE, INFORMATION PROCESSING METHOD, AND STORAGE MEDIUM

(71) Applicant: HONDA MOTOR CO., LTD., Tokyo (JP)

(72) Inventor: Takamasa Koshizen, Wako-shi (JP)

(21) Appl. No.: 19/169,061

(22) Filed: Apr. 3, 2025

(30) Foreign Application Priority Data
Apr. 26, 2024 (JP) 2024-073105
Jun. 25, 2024 (JP) 2024-101986

(51) Int. Cl. G06V 20/58; B60W 50/14; G06T 7/536

(52) U.S. Cl. CPC G06V 20/58; B60W 50/14; G06T 7/536

(57) ABSTRACT

An information processing device includes a storage medium that stores computer-readable instructions, and a processor connected to the storage medium, and the processor executes the computer-readable instructions to detect one or more other mobile objects from image data obtained by imaging an area around a mobile object, calculate a relative position of the other mobile objects in a lateral direction of the mobile object and a relative movement amount of the other mobile objects in a longitudinal direction of the mobile object, with the mobile object as a reference, cluster the other mobile objects based on the relative position of the other mobile objects in the lateral direction and the relative movement amount of the other mobile objects in the longitudinal direction, identify a lane area based on a result of the clustering, and estimate a center line of a lane on which the mobile object is traveling, based on the lane area.

### CROSS-REFERENCE TO RELATED APPLICATIONS

Priority is claimed on Japanese Patent Application No. 2024-073105, filed Apr. 26, 2024 and Japanese Patent Application No. 2024-101986, filed Jun. 25, 2024, the contents of which are incorporated herein by reference.

### BACKGROUND

### Field of the Invention

The present invention relates to an information processing device, an information processing method, and a storage medium.

### Description of Related Art

In the related art, a technology for detecting a lane on which a vehicle is traveling is known. For example, Japanese Unexamined Patent Application, First Publication No. 2018-106259 discloses a technology for extracting candidate lines that are candidates for marking lines from a road surface image, determining a line type, line color, and presence or absence of a backlighting effect of the extracted candidate lines, determining whether the extracted candidate lines constitute a multiple line, selecting the candidate lines serving as marking lines using a result of the determination, recognizing the selected candidate lines, and estimating a shape of a lane.

The technology described in Japanese Unexamined Patent Application, First Publication No. 2018-106259 is based on the premise of extracting candidate lines that are candidates for marking lines from the road surface image. However, for example, there are a case in which a plurality of other vehicles are traveling around a host vehicle, a case in which lane marking lines are not clear, or a case in which a lane on which a vehicle is traveling cannot be estimated appropriately.

### SUMMARY

The present invention has been made in consideration of these circumstances, and an object of the present invention is to provide an information processing device, information processing method, and storage medium capable of appropriately estimating a lane on which a host vehicle is traveling even when lane marking lines cannot be detected from a road surface image.

The information processing device, information processing method, and storage medium according to the present invention employ the following configurations.
(1): An information processing device according to one aspect of the present invention includes a detection unit that detects one or more other mobile objects from image data obtained by imaging an area around a mobile object, a calculation unit that calculates a relative position of the other mobile objects in a lateral direction of the mobile object and a relative movement amount of the other mobile objects in a longitudinal direction of the mobile object, with the mobile object as a reference, a clustering unit that clusters the other mobile objects based on the relative position of the other mobile objects in the lateral direction and the relative movement amount of the other mobile objects in the longitudinal direction, an identification unit that identifies a lane area based on a result of the clustering, and an estimation unit that estimates a center line of a lane on which the mobile object is traveling, based on the lane area.
(2): In the aspect (1), the identification unit identifies a host lane area indicating an area of a host lane on which the mobile object is traveling and a facing lane area representing an area facing the mobile object, based on the result of the clustering, and the estimation unit estimates the center line as a line between the host lane area and the facing lane area.
(3): In the aspect (2), the identification unit identifies a mobile object group approaching the mobile object from among a plurality of mobile object groups each belonging to a plurality of clusters obtained by the clustering, and identifies an area including a cluster to which the identified mobile object group belongs as the facing lane area.
(4): In the aspect (1), the estimation unit estimates a first vanishing point from an edge of the lane area, estimates another mobile object farthest from the mobile object as a second vanishing point, and identifies the first vanishing point or the second vanishing point as vanishing points when a distance between the first vanishing point and the second vanishing point is within a threshold value.
(5): In the aspect (1), when the estimation unit determines that the mobile object is traveling on a curved road, the estimation unit estimates the first vanishing point from an edge of the lane area, estimates another mobile object farthest from the mobile object as the second vanishing point, and identifies the first vanishing point or the second vanishing point as a vanishing point when a distance between the first vanishing point and the second vanishing point is within a threshold value.
(6): In the aspect (5), the estimation unit determines that the mobile object is traveling on a curved road when determining that a segment point exists on the center line.
(7): In the aspect (1), the clustering unit clusters one or more other mobile objects detected from the image data for a plurality of frames captured in time series.
(8): In the aspect (1), the clustering unit clusters the other mobile objects based on the relative position of the other mobile objects in the lateral direction and a moving average of the relative movement amount of the other mobile objects in the longitudinal direction.
(9): In the aspect (1), the clustering unit clusters only the other mobile objects that are four-wheeled vehicles.
(10): In the aspect (1), the detection unit detects the other mobile object located behind the mobile object, and the information processing device further includes a movement direction estimation unit that estimates a movement direction of the other mobile object based on the relative position of the other mobile object in the lateral direction and the relative movement amount of the other mobile object in the longitudinal direction, and a determination unit that determines whether the other mobile object will overtake based on the estimated movement direction of the other mobile object and the lane area.
(11): In the aspect (10), the determination unit further includes a notification unit that notifies a passenger of the mobile object of overtaking when it is determined that the other mobile object will overtake the mobile object.
(12): An information processing method according to another aspect of the present invention includes detecting, by a computer, one or more other mobile objects from image data obtained by imaging an area around a mobile object; calculating, by the computer, a relative position of the other mobile objects in a lateral direction of the mobile object and a relative movement amount of the other mobile objects in a longitudinal direction of the mobile object, with the mobile object as a reference; clustering, by the computer, the other mobile objects based on the relative position of the other mobile objects in the lateral direction and the relative movement amount of the other mobile objects in the longitudinal direction; identifying, by the computer, a lane area based on a result of the clustering; and estimating, by the computer, a center line of a lane on which the mobile object is traveling, based on the lane area.
(13): A computer-readable non-transitory storage medium storing a program according to still another aspect of the present invention stores a program that causes a computer to: detect one or more other mobile objects from image data obtained by imaging an area around a mobile object, calculate a relative position of the other mobile objects in a lateral direction of the mobile object and a relative movement amount of the other mobile objects in a longitudinal direction of the mobile object, with the mobile object as a reference; cluster the other mobile objects based on the relative position of the other mobile objects in the lateral direction and the relative movement amount of the other mobile objects in the longitudinal direction, identify a lane area based on a result of the clustering, and estimate a center line of a lane on which the mobile object is traveling, based on the lane area.

According to the aspects (1) to (13), it is possible to appropriately estimate a lane on which the host vehicle is traveling even when lane marking lines cannot be detected from a road surface image.

### BRIEF DESCRIPTION OF THE DRAWINGS

FIG. 1 is a diagram illustrating an example of a usage environment of a terminal device 100 mounted on a host vehicle M.

FIG. 2 is a diagram illustrating an example of a configuration of the terminal device.

FIG. 3 is a diagram illustrating an example of one or more other vehicles detected from a captured image by a detection unit.

FIG. 4 is a diagram illustrating an example of a scene in which a calculation unit calculates a relative position between a host vehicle and another vehicle.

FIG. 5 is a diagram illustrating a method in which the calculation unit calculates a position in a longitudinal direction between the host vehicle and the other vehicle.

FIG. 6 is a diagram illustrating a method in which the calculation unit calculates a position in a lateral direction between the host vehicle and the other vehicle.

FIG. 7 is a diagram illustrating an example of a bird's-eye view generated by the calculation unit.

FIG. 8 is a diagram illustrating an overview of clustering executed by a clustering unit.

FIG. 9 is a diagram illustrating a method in which a lane area including the host vehicle M is identified by an identification unit.

FIG. 10 is a diagram illustrating an example of a center line and a vanishing point estimated by an estimation unit.

FIG. 11 is a diagram illustrating a process of the estimation unit when the host vehicle is traveling on a curved road.

FIG. 12 is a flowchart showing an example of a flow of a process executed by the terminal device.

FIG. 13 is a diagram illustrating an example of a usage environment of the terminal device mounted on the host vehicle M according to a second embodiment.

FIG. 14 is a diagram illustrating an example of a configuration of the terminal device according to the second embodiment.

FIG. 15 is a diagram illustrating details of an overtaking determination and notification process.

FIG. 16 is a flowchart showing an example of a flow of a process executed by the terminal device.

### DESCRIPTION OF EMBODIMENTS

Hereinafter, embodiments of an information processing device, information processing method, and storage medium of the present invention will be described with reference to the drawings.

### [Configuration]

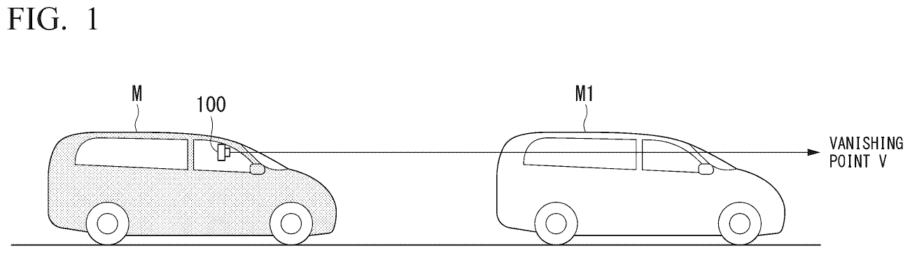

FIG. 1 shows an example of a usage environment of a terminal device 100 mounted on a vehicle M. The host vehicle M is, for example, a two-wheeled, three-wheeled, or four-wheeled vehicle, and its driving source is an internal combustion engine such as a diesel engine or a gasoline engine, an electric motor, or a combination thereof. The electric motor operates using power generated by a generator connected to the internal combustion engine, or discharged power from a secondary battery or a fuel cell.

As illustrated in FIG. 1, the terminal device 100 is installed on the host vehicle M to be able to image an area ahead of the host vehicle M in a traveling direction. The terminal device 100 is, for example, a computer device such as a smartphone or a tablet terminal. The terminal device 100 is held, for example, by an in-vehicle holder (not shown) attached to a dashboard of the host vehicle M, and images the area ahead of the host vehicle M.

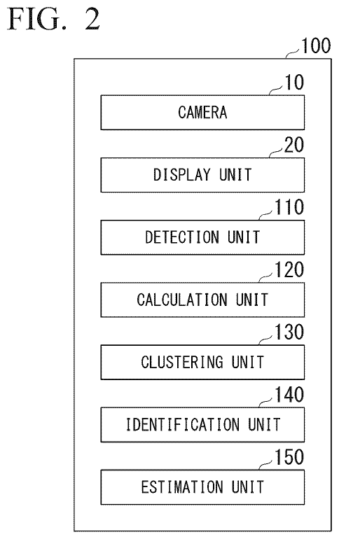

FIG. 2 is a diagram illustrating an example of a configuration of the terminal device 100. As illustrated in FIG. 2, the terminal device 100 includes, for example, a camera 10, a display unit 20, a detection unit 110, a calculation unit 120, a clustering unit 130, an identification unit 140, and an estimation unit 150. The detection unit 110, the calculation unit 120, the clustering unit 130, the identification unit 140, and the estimation unit 150 are realized, for example, by a hardware processor such as a central processing unit (CPU) executing a program (software). Some or all of these components may be realized by hardware (including circuitry) such as a large scale integration (LSI), an application specific integrated circuit (ASIC), a field programmable gate array (FPGA), or a graphics processing unit (GPU), or may be realized by cooperation between software and hardware. The program may be stored in advance in a storage device (a storage device including a non-transient storage medium) such as a hard disk drive (HDD) or a flash memory, or may be stored in a removable storage medium (a non-transient storage medium) such as a DVD or a CD-ROM and may be installed by the storage medium being mounted in a drive device. In the following description, functions of the detection unit 110, the calculation unit 120, the clustering unit 130, the identification unit 140, and the estimation unit 150 may be collectively referred to as an “information processing application”. The information processing application is installed in the terminal device 100, and is activated, for example, when a user of the terminal device 100 starts driving the host vehicle M. The terminal device 100 with the information processing application installed therein is an example of an “information processing device.”

The camera 10 is, for example, a digital camera that uses a solid-state image sensor such as a charge coupled device (CCD) or a complementary metal oxide semiconductor (CMOS). The display unit 20 is, for example, a display device such as a touch panel or a liquid crystal display. The display unit 20 displays an estimation result from the estimation unit 150, which will be described later. The user of the terminal device 100 aligns the terminal device 100 to a predetermined height (an initial height of a vanishing point V, which will be described later) along a guide line displayed on the display unit 20. FIG. 1 shows a state in which the terminal device 100 is aligned to image the vicinity of an upper end of another vehicle M1 of the host vehicle M in a substantially horizontal direction with respect to a road surface.

### [Detection Unit]

The detection unit 110 recognizes an object captured in the image IM captured by the camera 10. More specifically, for example, the detection unit 110 detects the object using a trained model that has been trained to output information such as the presence, position, and type of the object when an image captured by the camera 10 is input. The detection unit 110 uses this trained model to detect one or more other vehicles in the captured image IM while distinguishing between types such as a two-wheeled vehicle and a four-wheeled vehicle.

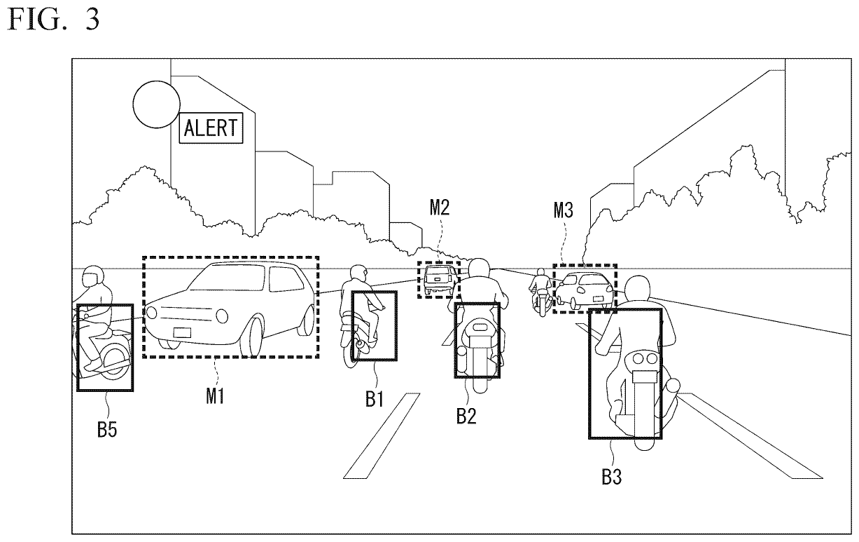

FIG. 3 is a diagram illustrating an example of one or more other vehicles detected by the detection unit 110 from the captured image IM. In FIG. 3, reference signs M1 to M3 denote four-wheeled vehicles detected by the detection unit 110, and reference signs B1 to B3 denote two-wheeled vehicles detected by the detection unit 110. The terminal device 100 displays the other vehicles detected by the detection unit 110 on the display unit 20, for example, by surrounding the other vehicles with a bounding box. In FIG. 3, the detected four-wheeled vehicles and two-wheeled vehicles are displayed with the same bounding box, but the two-wheeled vehicles and four-wheeled vehicles may be displayed on the display unit 20 in different display modes.

### [Calculation Unit]

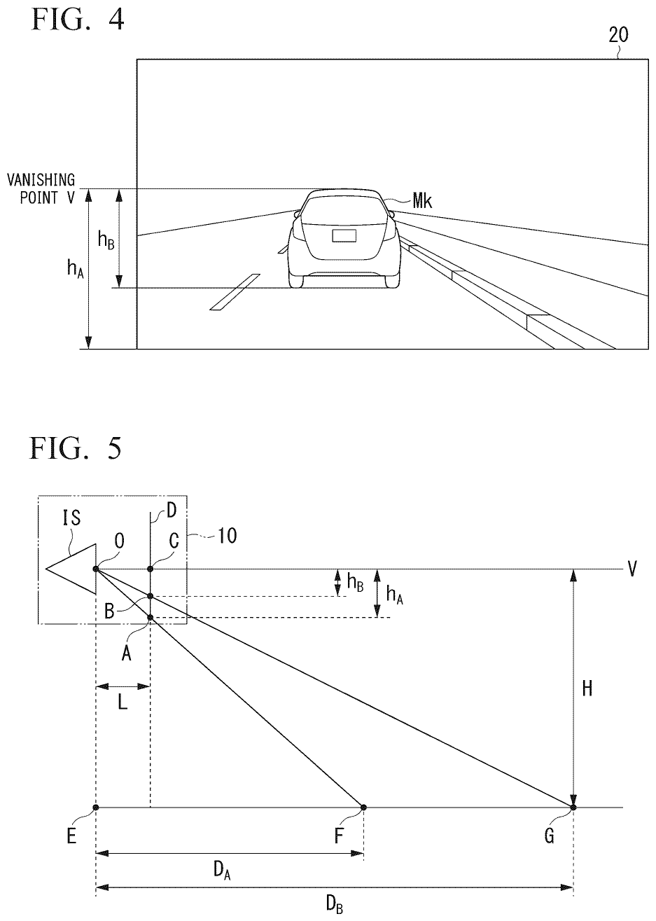

When the detection unit 110 detects one or more other vehicles, the calculation unit 120 further calculates a position in a longitudinal direction and a position in a lateral direction (hereinafter, a combination of the position in the longitudinal direction and the position in the lateral direction may be referred to as a “relative position”) of the one or more other vehicles relative to the host vehicle M. FIG. 4 is a diagram illustrating an example of a scene in which the calculation unit 120 calculates a relative position between the host vehicle M and another vehicle Mk. In FIG. 4, reference sign hA denotes a height from a road position corresponding to a bottom end of the display unit 20 to the vanishing point V of the image, and reference sign hB denotes a height from the road position corresponding to a bottom end of the detected other vehicle M1 to the vanishing point V of the image.

FIG. 5 is a diagram illustrating a method in which the calculation unit 120 calculates a position in a longitudinal direction between the host vehicle M and the other vehicle. In FIG. 5, reference sign IS denotes an image sensor included in the camera 10, reference sign D denotes a display included in the camera 10 (an end of the camera 10), reference sign O denotes a center portion of the image sensor, reference sign A denotes a position on the display D corresponding to a road position F shown on a lower portion of the display D, reference sign B denotes a position on the display D corresponding to a road position G at a rear end of the other vehicle M1, reference sign C denotes an intersection between an imaging direction of the image sensor and the display D, reference sign H denotes a height of the camera 10 with the road surface as a reference, reference sign DA denotes a distance from a position of an image sensor IS to the road position F shown on the lower portion of the display D, and reference sign DB denotes a distance from the position of the image sensor IS to the road position G at the rear end of the other vehicle M1.

In FIG. 5, triangles OAC and OEF are similar to each other, and triangles OBC and OEG are similar to each other. That is, since L:hA=DA:H and L:hB=DB:H are established for a distance, DA=L×H/hA and DB=L×H/hB are obtained by transformation. Therefore, the calculation unit 120 can calculate the distance to the road position G at the rear end of the other vehicle M1 using a calculation formula DB=DA×hA/hB. Here, the heights hA and hB to the vanishing point can be calculated in advance based on the image captured by the camera 10, and the distance DA that does not depend on a position of the other vehicle M1 can be calculated in advance according to an installation position of the terminal device 100. The above calculation can be executed using only height information of the vanishing point without requiring all coordinate information of the vanishing point.

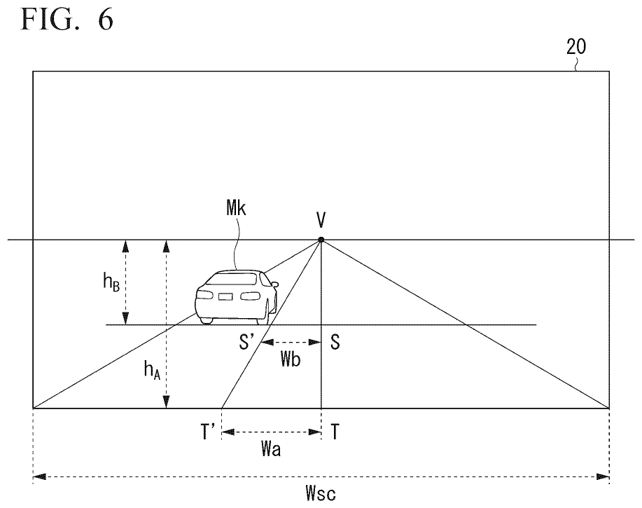

The calculation unit 120 further calculates the position in the lateral direction between the host vehicle M and the other vehicle. FIG. 6 is a diagram illustrating a method in which the calculation unit 120 calculates the position in the lateral direction between the host vehicle M and the other vehicle. In FIG. 6, reference sign V denotes the vanishing point of the image, reference sign Wb denotes the number of pixels in the lateral direction with the vanishing point V of the other vehicle M1 as a reference, and reference sign Wa denotes the number of pixels when the number Wb of pixels moves to a bottom end of the display D.

In FIG. 6, triangles VT′T and VS′S are in a similar relationship. That is, since Wa:hA==Wb: hB is satisfied in terms of a distance, Wa=Wb×hA/hB is obtained by transformation. Here, assuming that a total number of pixels Wsc at a lower end of the display D and a width Wrd of a road on which the host vehicle M is traveling are known, the calculation unit 120 can calculate an actual distance W in the lateral direction corresponding to the number of pixels Wa using a calculation formula W=Wrd×Wa/Wsc. Thus, the calculation unit 120 calculates a relative position between the host vehicle M and the other vehicle M1.

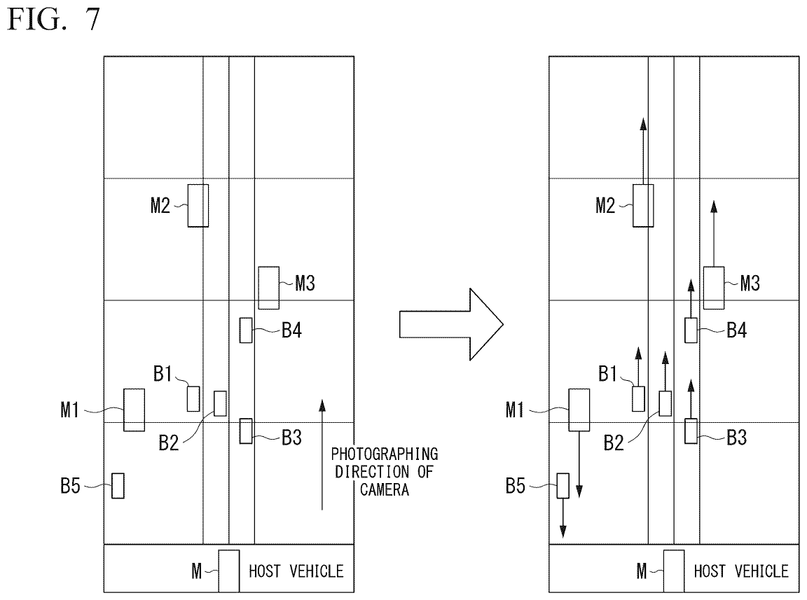

When the calculation unit 120 calculates relative positions of one or more other vehicles with respect to the host vehicle M, the calculation unit 120 maps the one or more other vehicles onto a bird's-eye view with the host vehicle M as a reference. FIG. 7 is a diagram illustrating an example of a bird's-eye view generated by the calculation unit 120. A left part of FIG. 7 shows a screen in which the calculation unit 120 calculates relative positions of one or more other vehicles with the host vehicle M as a reference based on the situation illustrated in FIG. 3 and maps them onto the bird's-eye view.

The calculation unit 120 further calculates the relative positions of the other vehicles for T frames (T is a positive integer) of images captured in time series by the camera 10, and calculates a relative movement amount of the other vehicles with the host vehicle M as a reference based on a difference between the relative positions in time series. More specifically, the calculation unit 120 calculates the relative position of the other vehicle at time t (k) (k is an integer between 1 and T) and the relative movement amount of the other vehicle over a period t(k)−t(k−1). Arrows shown on a right part of FIG. 7 indicate a direction and magnitude of a relative movement amount of each other vehicle.

### [Clustering Unit]

The clustering unit 130 clusters one or more other vehicles based on a relative position of the other vehicle in a lateral direction of the host vehicle M and a relative movement amount of the other vehicle in a longitudinal direction of the host vehicle M, which are calculated by the calculation unit 120.

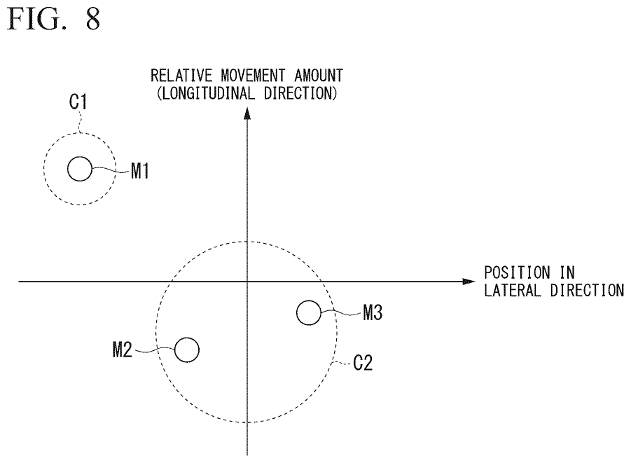

FIG. 8 is a diagram illustrating an overview of the clustering executed by the clustering unit 130. In the present embodiment, the clustering unit 130 represents the relative movement amount in the longitudinal direction and the position in the lateral direction calculated for each other vehicle on a two-dimensional graph, and clusters the other vehicles by applying a k-means method to such values. FIG. 8 shows a result of clustering with the position in the lateral direction as an X coordinate, the relative movement amount as a Y coordinate, and k=2. More generally, in order to determine a value of k, the clustering unit 130 may calculate a distance between an average value of each cluster and each data value when clustering has been executed with each value of k (for example, 2 to 5), obtain a sum of the distances, and adopt a value of k that minimizes the sum of the distances.

In the present embodiment, as illustrated in FIG. 8, the clustering unit 130 executes clustering only on four-wheeled vehicles among the detected other vehicles. This is because the four-wheeled vehicles generally have smoother traveling trajectories than two-wheeled vehicles and tend to travel along a lane that is an estimation target. It is possible to improve the accuracy of the identified vanishing point compared to a case where two-wheeled vehicles are included, by limiting a clustering target to the four-wheeled vehicles. Alternatively, the clustering unit 130 may execute clustering not only on four-wheeled vehicles but also on two-wheeled vehicles. When clustering is performed including the two-wheeled vehicles, the clustering unit 130 may determine whether or not at least a predetermined number of four-wheeled vehicles are present in the captured image, and may perform clustering including the two-wheeled vehicles only when it is determined that there are fewer than the predetermined number of four-wheeled vehicles.

The present invention is not limited to the k-means method and, for example, clustering may be performed using other unsupervised algorithms (for example, a mixture Gaussian distribution model or a hypervolume method). Also, while FIG. 8 shows a case where a position in a lateral direction of another vehicle at time t(k) and a relative movement amount of the other vehicle over the period t(k)−t(k−1) are clustered, but clustering may be performed on a moving average value of the position in the lateral direction and/or the relative movement amount with time t(1) as a starting point for each other vehicle in order to stabilize a clustering result. Accordingly, the clustering result can be stablized. Alternatively, for example, a Bayesian estimator may be derived from observation values in time series related to the relative movement amount and the position in the lateral direction instead of the moving average value, and the derived Bayesian estimator may be clustered.

### [Identification Unit]

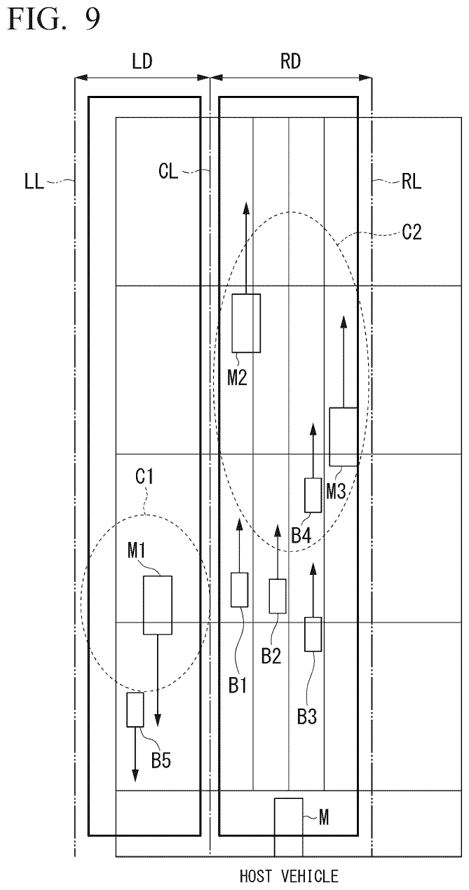

FIG. 9 is a diagram illustrating a method for identifying a lane area including the host vehicle M using the identification unit 140. When each cluster is obtained by the clustering unit 130, the identification unit 140 obtains a width of the cluster, identifies left and right ends of the obtained width as the left lane marking line and the right lane marking line (hereinafter, a combination of the left lane marking line and the right lane marking line may be referred to as an “edge”), and identifies an area surrounded by the left lane marking line and the right lane marking line as a lane area. In the case of FIG. 9, the identification unit 140 identifies a left lane marking line LL and a right lane marking line CL for a cluster C1, and identifies an area surrounded by the left lane marking line LL and the right lane marking line CL as a lane area LD. Further, the identification unit 140 identifies a left lane marking line CL and the right lane marking line RL for a cluster C2, and identifies an area surrounded by the left lane marking line CL and the right lane marking line RL as a lane area RD.

When the identification unit 140 identifies one or more lane areas, the identification unit 140 identifies an area representing the host lane on which the host vehicle M is traveling among the lane areas as a host lane area, and identifies lane areas other than the host lane area as other lane areas. The identification unit 140 further identifies whether the other lane area is a facing lane area representing an area facing the host vehicle M, based on the relative movement amount of the other vehicle constituting each cluster. More specifically, for example, when the identification unit 140 determines that the other vehicle constituting each cluster is approaching the host vehicle M based on the relative movement amount of the other vehicle constituting each cluster (that is, the identification unit 140 determines that the relative movement amount is determined to be negative), the identification unit 140 can identify the cluster as the facing lane area. When a cluster includes a plurality of other vehicles, the identification unit 140 may identify the cluster as the facing lane area, for example, when a sum of the relative movement amounts is negative, or may identify whether or not the cluster is the facing lane area by a majority vote based on the number of other vehicles with negative relative movement amounts.

### [Estimation Unit]

The estimation unit 150 estimates a center line of the host lane area in which the host vehicle M is traveling based on the lane area identified by the identification unit 140. More specifically, for example, when there are a plurality of lane areas identified by the identification unit 140, the estimation unit 150 estimates a line between the plurality of identified lane areas as the center line. For example, in the case of FIG. 9, the estimation unit 150 estimates the line CL passing between the lane area LD and the lane area RD as the center line. In particular, when the identification unit 140 has identified the host lane area and the facing lane area, the estimation unit 150 can estimate the line CL that passes between the host lane area and the facing lane area as the center line.

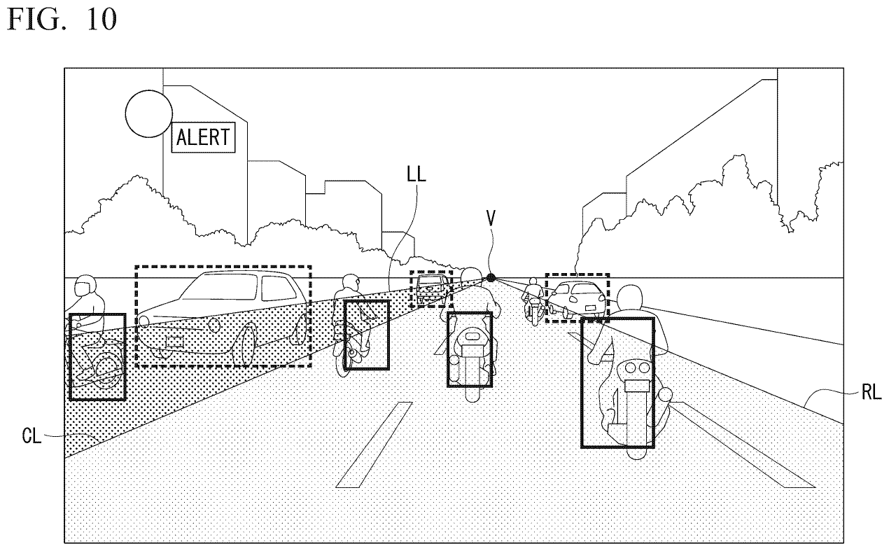

FIG. 10 is a diagram illustrating an example of a center line and a vanishing point estimated by the estimation unit 150. When the estimation unit 150 estimates the center line CL, the terminal device 100 displays the estimated center line CL on the display unit 20. In this case, as illustrated in FIG. 10, the terminal device 100 also displays the left lane marking line CL and the right lane marking line RL in addition to the estimated center line CL. A driver of the host vehicle M can ascertain the lane on which the host vehicle M is traveling by referring to the center line CL, the left lane marking line CL, and the right lane marking line RL. That is, according to the present embodiment, it is possible to appropriately estimate the lane on which the host vehicle is traveling even when the lane marking lines cannot be detected from the road surface image.

When the left lane marking line CL and the right lane marking line RL are identified by the identification unit 140, the estimation unit 150 identifies an intersection between the identified left lane marking line CL and right lane marking line RL (that is, edges) as the vanishing point V. Alternatively, the estimation unit 150 may identify an intersection between either the left lane marking line CL or the right lane marking line RL and the center line CL as the vanishing point V. When the vanishing point Vis identified in this way, the detection unit 110 and the calculation unit 120 use the identified vanishing point V to execute the processing described in FIGS. 3 to 7 again and regenerate the bird's-eye view. By repeating such processing, it is possible to improve the accuracy of the bird's-eye view.

### [Existence of Division Point]

The processing described above is applicable regardless of whether the road on which the host vehicle M is traveling is a straight road or a curved road. However, it is known that when the host vehicle M is traveling on the curved road, the lane estimation based on the above clustering lacks stability. Therefore, the estimation unit 150 determines whether or not a division point from a straight road to a curved road exists on the road on which the host vehicle M is traveling. More specifically, for example, the estimation unit 150 may calculate a second-order derivative of the center line CL identified by the identification unit 140, and estimate a point where a sign of the calculated derivative changes as a division point DP. Also, for example, the estimation unit 150 may calculate a curvature of the center line CL identified by the identification unit 140, and estimate a point where the calculated curvature is equal to or greater than a threshold value as the division point DP.

When it is determined that the division point exists, the estimation unit 150 considers another vehicle located farthest from the host vehicle M as the vanishing point V2 in addition to the vanishing point V1, which is an intersection point between the left lane marking line CL and the right lane marking line RL described above, and verifies the reliability of lane estimation based on clustering by determining whether there is a deviation between the vanishing point V1 and the vanishing point V2.

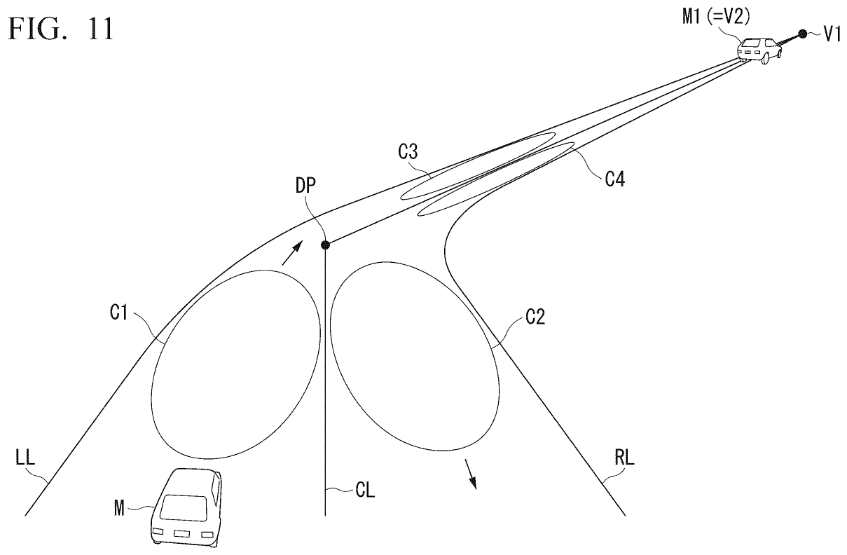

FIG. 11 is a diagram illustrating a process of the estimation unit 150 when the host vehicle M travels on a curved road. FIG. 11 shows, as an example, a case in which the clusters C1 to C4 have been detected as a result of the clustering.

When it is determined that the division point exists, the estimation unit 150 considers the other vehicle M1 located farthest from the host vehicle M as the vanishing point V2. Next, the estimation unit 150 determines whether a distance between the vanishing point V1 as an intersection between the left lane marking line CL and the right lane marking line RL and the vanishing point V2 as the other vehicle M1 is within a threshold value. When it is determined that the distance between the vanishing point V1 and the vanishing point V2 is within the threshold value, the estimation unit 150 identifies either the vanishing point V1 or the vanishing point V2 as the vanishing point V. When the vanishing point V is identified in this manner, the detection unit 110 and the calculation unit 120 use the identified vanishing point V to execute the process described in FIGS. 3 to 7 again and regenerate the bird's-eye view. By repeating such a process, it is possible to improve the accuracy of the bird's-eye view.

In the present embodiment, a case in which the terminal device 100 is installed to image the area ahead of the host vehicle M, and the vanishing point in the area ahead of the host vehicle M is identified has been described as an example. However, the present invention is not limited to such a configuration, and the terminal device 100 may be installed to image the area behind the host vehicle M, and a vanishing point in the area behind the host vehicle M may be identified. In this case, the generated bird's-eye view shows the area behind the host vehicle M, and an occupant of the host vehicle M can confirm a situation behind the host vehicle M by confirming the bird's-eye view. Further, for example, two or more terminal devices 100 may be installed to image the area in front of the host vehicle M and the area behind the host vehicle M, the bird's-eye view of the area in front of the host vehicle and the bird's-eye view of the area behind the host vehicle generated by the two or more terminal devices 100 may be integrated, and displayed on one of the terminal devices 100 or a navigation device of the host vehicle M.

### [Processing Flow]

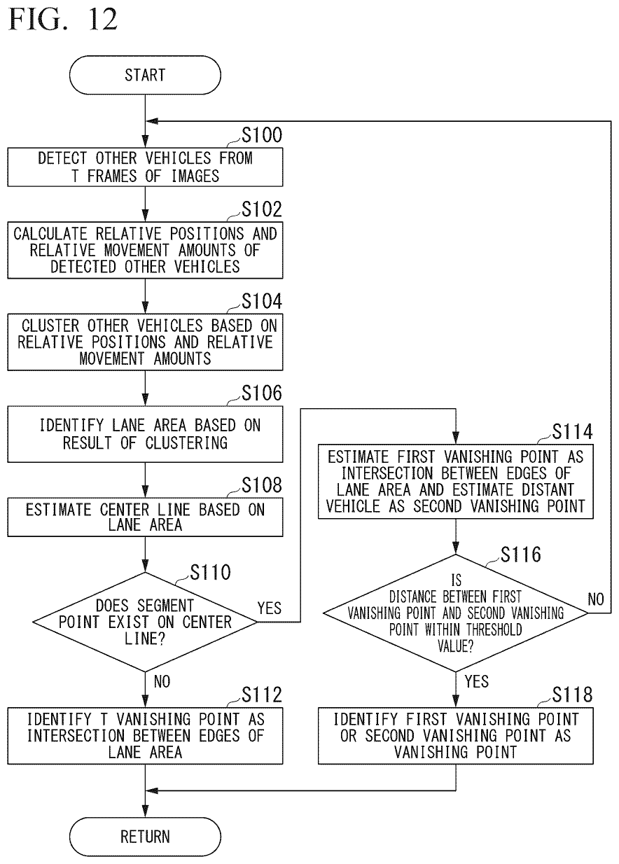

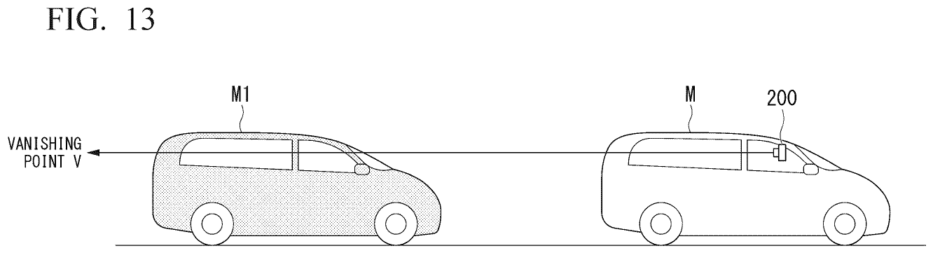

Next, a processing flow executed by the terminal device 100 will be described with reference to FIG. 12. FIG. 12 is a flowchart showing an example of a processing flow executed by the terminal device 100. The process of the flowchart illustrated in FIG. 12 is executed repeatedly, for example, while the host vehicle M is traveling.

First, the detection unit 110 detects a plurality of other vehicles from T frames of images captured in time series by the camera 10 (step S100). Next, the calculation unit 120 calculates the relative positions and relative movement amounts of the detected other vehicles (step S102). Next, the clustering unit 130 clusters the other vehicles based on the calculated relative positions and relative movement amounts of the other vehicles (step S104). Next, the identification unit 140 identifies a lane area based on a result of the clustering (step S106). Next, the estimation unit 150 estimates the center line based on the identified lane area (step S108).

Next, the estimation unit 150 determines whether or not the segment point exists on the estimated center line (step S110). When it is determined that the segment point does not exist on the estimated center line, the estimation unit 150 identifies the vanishing point V as an intersection between edges of the identified lane area (step S112). On the other hand, when it is determined that the segment point exists on the estimated center line, the estimation unit 150 estimates the first vanishing point V1 as the intersection between the edges of the lane area, and estimates the distant vehicle as the second vanishing point V2 (step S114).

Next, the estimation unit 150 determines whether a distance between the first vanishing point V1 and the second vanishing point V2 is within a threshold value (step S116). When it is determined that the distance between the first vanishing point V1 and the second vanishing point V2 is not within the threshold value, the terminal device 100 returns the process to step S100. On the other hand, when it is determined that the distance between the first vanishing point V1 and the second vanishing point V2 is within the threshold value, the estimation unit 150 identifies the first vanishing point V1 or the second vanishing point V2 as the vanishing point V (step S118). Accordingly, the process of this flowchart ends.

According to the present embodiment described above, the detected other mobile objects are clustered based on the relative positions and relative movement amounts of the other mobile objects, the lane area is identified based on a result of the clustering, and a center line of the lane is estimated based on the lane areas. Accordingly, it is possible to appropriately estimate the lane on which the host vehicle is traveling even when lane marking lines cannot be detected from the road surface image.

### SECOND EMBODIMENT

FIG. 13 is a diagram illustrating an example of a usage environment of the terminal device 200 mounted on the host vehicle M according to a second embodiment. In the above embodiment, the terminal device 100 is installed on the host vehicle M to be able to image an area ahead in a traveling direction of the host vehicle M. On the other hand, in the second embodiment, as illustrated in FIG. 13, the terminal device 200 is installed on the host vehicle M to be able to image an area behind the host vehicle M in a direction opposite to the traveling direction of the host vehicle M. As will be described below, in the second embodiment, the terminal device 200 not only identifies the lane area in the direction opposite to the traveling direction of the host vehicle M, but also determines whether or not the other vehicle will overtake the host vehicle M based on the relative position and the relative movement amount of the other vehicle traveling in the area behind the host vehicle M, and performs notifying the occupant of the host vehicle M that the other vehicle will overtake the host vehicle M when it is determined that the other vehicle will overtake the host vehicle M.

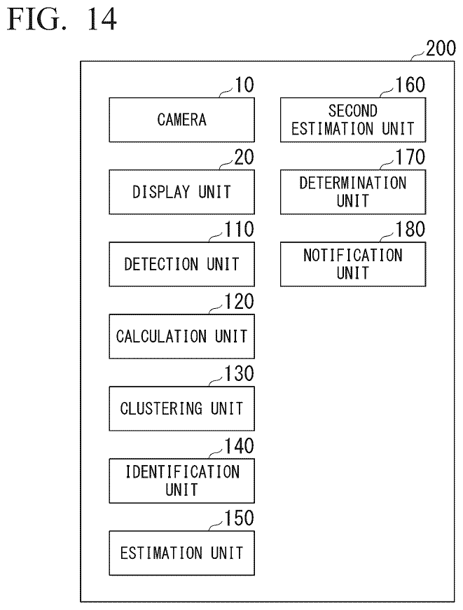

FIG. 14 is a diagram illustrating an example of a configuration of the terminal device 200 according to the second embodiment. The terminal device 200 includes a second estimation unit 160, a determination unit 170, and a notification unit 180, in addition to functions of the terminal device 100 according to the first embodiment. The second estimation unit 160, the determination unit 170, and the notification unit 180 are realized, for example, by a hardware processor such as a CPU executing a program (software). Some or all of these components may be realized by hardware (including circuitry) such as an LSI, ASIC, FPGA, or GPU, or may be realized by a combination of software and hardware. The program may be stored in advance in a storage device (a storage device including a non-transient storage medium) such as an HDD or flash memory, or may be stored in a removable storage medium (a non-transient storage medium) such as a DVD or CD-ROM and installed by the storage medium being mounted on a drive device.

Functions of the detection unit 110, the calculation unit 120, the clustering unit 130, the identification unit 140, and the estimation unit 150 are the same as those in the first embodiment. That is, the detection unit 110 detects a plurality of other vehicles from the T frames of images that are captured in time series by the camera 10 and show the area behind the host vehicle M. The calculation unit 120 calculates a relative position in the lateral direction and a relative movement amount in the longitudinal direction of the other vehicle detected in the area behind the host vehicle M. The clustering unit 130 clusters the other vehicles based on the calculated relative positions and relative movement amounts of the other vehicles. The identification unit 140 identifies the lane area based on a result of the clustering. The estimation unit 150 estimates the center line based on the identified lane area.

The second estimation unit 160 estimates the movement direction of the other vehicle based on the relative position in the lateral direction and the relative movement amount in the longitudinal direction of the other vehicle calculated by the calculation unit 120. More specifically, for example, the second estimation unit 160 can calculate the relative position in the lateral direction of the other vehicle in a time series, and estimate the movement direction in the lateral direction of the other vehicle depending on whether a difference between the calculated relative positions in time series has a positive value (rightward) or a negative value (leftward). The second estimation unit 160 can further estimate the movement direction in the longitudinal direction of the other vehicle depending on whether the relative movement amount in the longitudinal direction has a positive value (forward) or a negative value (backward). The second estimation unit 160 can combine results of the estimations in the lateral and longitudinal directions, and estimate that the traveling direction of the other vehicle is a “right-forward direction”, for example, when the calculated difference in the relative positions in time series has a positive value (rightward) and the relative movement amount in the longitudinal direction has a positive value (forward).

The second estimation unit 160 may estimate the movement direction using a threshold value in consideration of a slight difference or error in the relative position and the relative movement amount. For example, the second estimation unit 160 may estimate whether the difference has a positive value (rightward) or a negative value (leftward) only when a calculated absolute value of the difference in the relative position in time series is equal to or greater than a threshold value. Further, the second estimation unit 160 may estimate whether the relative movement amount has a positive value (forward) or a negative value (backward) only when an absolute value of the relative movement amount in the longitudinal direction is equal to or greater than a threshold value.

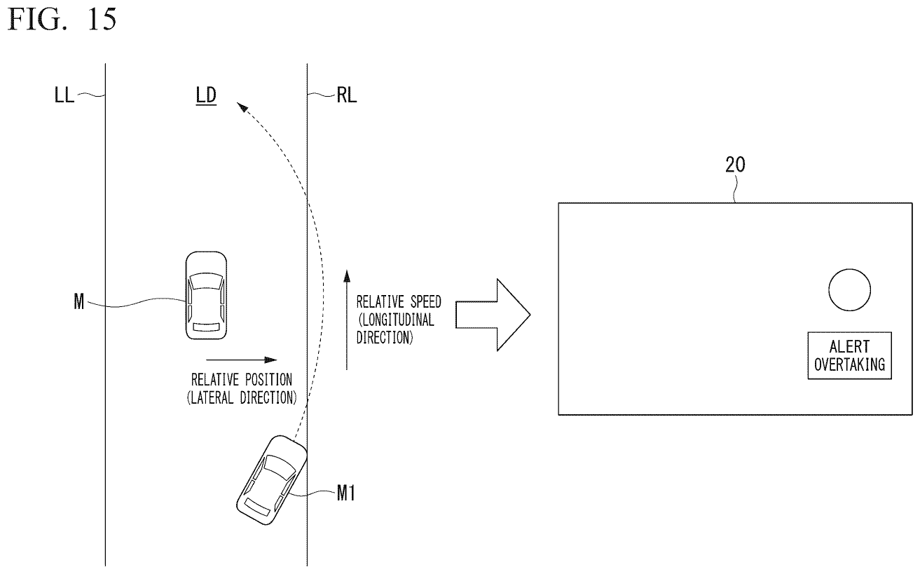

FIG. 15 is a diagram illustrating details of an overtaking determination and notification process. In FIG. 15, reference signs LL and RL denote the left lane marking line LL and the right lane marking line CL identified by the identification unit 140, and the identification unit 140 identifies the area surrounded by the left lane marking line LL and the right lane marking line CL as the lane area LD. Also, in FIG. 15, as an example, a case in which the second estimation unit 160 estimates that a traveling direction of the other vehicle M1 is a “right forward direction” is shown. The determination unit 170 determines whether or not the other vehicle M1 will overtake the host vehicle M based on the estimated movement direction estimated by the second estimation unit 160 and the lane area LD identified by the identification unit 140. More specifically, for example, the determination unit 170 determines that the other vehicle M1 will overtake the host vehicle M when the estimated movement direction estimated by the second estimation unit 160 is the “right forward direction” or “left forward direction” and the position of the other vehicle M1 is within a predetermined distance from the left lane marking line LL or the right lane marking line CL. In this case, the determination unit 170 may consider whether a relative movement amount of the other vehicle M1 in the longitudinal direction is equal to or greater than a threshold value (that is, whether the other vehicle M1 is traveling at a higher speed than the host vehicle M). In another embodiment, the determination unit 170 may determine that the other vehicle M1 will overtake the host vehicle M when the position of the other vehicle M1 is within the predetermined distance from the left lane marking line LL or the right lane marking line CL, even when the estimated movement direction estimated by the second estimation unit 160 is a “right direction” or “left direction” (that is, even when the relative movement amount in the longitudinal direction does not have a positive value). More generally, the determination unit 170 may perform the overtaking determination using at least one of the estimated movement direction estimated by the second estimation unit 160 and the lane area LD identified by the identification unit 140.

When the determination unit 170 determines that the other vehicle M1 will overtake the host vehicle M, the notification unit 180 notifies the occupant of the host vehicle M of the overtaking. More specifically, for example, as shown in a right part of FIG. 15, the notification unit 180 causes the display unit 20 to display alert information indicating that the other vehicle M1 attempts to overtake the host vehicle M. In this case, when it is determined that the other vehicle M1 will overtake the host vehicle M from the right, the notification unit 180 may cause the alert information to be displayed on the right side of the display unit 20, or when it is determined that the other vehicle M1 will overtake the host vehicle M from the left, the notification unit 180 may cause the alert information to be displayed on the left side of the display unit 20. Alternatively, the notification unit 180 may utilize an audio output function of the terminal device 100 to notify that the other vehicle M1 attempts to overtake the host vehicle M by audio.

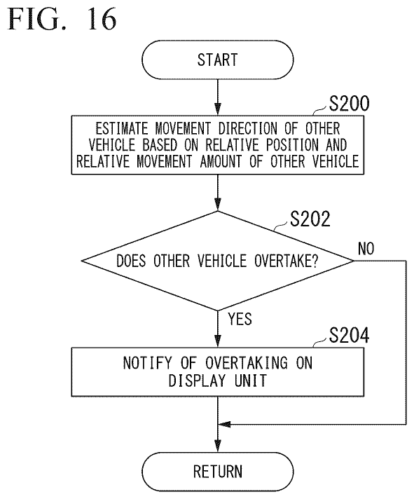

FIG. 16 is a flowchart showing an example of a flow of a process executed by the terminal device 200. The process of the flowchart illustrated in FIG. 16 is executed on the premise that the lane area of the host vehicle M is identified by the identification unit 140 while the host vehicle M is traveling.

First, the second estimation unit 160 estimates a movement direction of the other vehicle based on the relative position in the lateral direction and the relative movement amount in the longitudinal direction of the other vehicle calculated by the calculation unit 120 (step S200). Next, the determination unit 170 determines whether or not the other vehicle will overtake the host vehicle based on the estimated movement direction estimated by the second estimation unit 160 and the lane area identified by the identification unit 140 (step S202). When it is determined that the other vehicle will not overtake the host vehicle, the terminal device 200 ends the process. On the other hand, when it is determined that the other vehicle will overtake the host vehicle, the notification unit 180 notifies the display unit 20 of a lane change (step S204). Accordingly, the process of this flowchart ends.

According to the second embodiment described above, even when the lane marking lines cannot be detected from the road surface image, it is possible to appropriately estimate the lane on which the host vehicle is traveling and to suitably perform driving assistance for the occupant of the host vehicle using the estimated traveling lane.

The embodiment described above can be represented as follows.

An information processing device including: a storage medium storing computer-readable instructions; and
a processor connected to the storage medium,
wherein the processor executes the computer-readable instructions to:
   detect one or more other mobile objects from image data obtained by imaging an area around the mobile objects,
   calculate a relative position of the other mobile objects in a lateral direction of the mobile object and a relative movement amount of the other mobile objects in a longitudinal direction of the mobile object, with the mobile object as a reference,
   cluster the other mobile objects based on the relative position of the other mobile objects in the lateral direction and the relative movement amount of the other mobile objects in the longitudinal direction,
   identify a lane area based on a result of the clustering, and
   estimate a center line of the lane on which the mobile object is traveling, based on the lane area.

Although forms for implementing the present invention have been described using the embodiments, the present invention is not limited to such embodiments in any way, and various modifications and substitutions can be made without departing from the gist of the present invention.

What is claimed is:

1. An information processing device comprising:
a storage medium configured to store computer-readable instructions; and
a processor connected to the storage medium,
wherein the processor executes the computer-readable instructions to:
detect one or more other mobile objects from image data obtained by imaging an area around a mobile object,
calculate a relative position of the other mobile objects in a lateral direction of the mobile object and a relative movement amount of the other mobile objects in a longitudinal direction of the mobile object, with the mobile object as a reference,
cluster the other mobile objects based on the relative position of the other mobile objects in the lateral direction and the relative movement amount of the other mobile objects in the longitudinal direction,
identify a lane area based on a result of the clustering, and
estimate a center line of a lane on which the mobile object is traveling, based on the lane area.

2. The information processing device according to claim 1, wherein
the processor identifies a host lane area indicating an area of a host lane on which the mobile object is traveling and a facing lane area representing an area facing the mobile object, based on the result of the clustering, and
the processor estimates the center line as a line between the host lane area and the facing lane area.

3. The information processing device according to claim 2, wherein the processor identifies a mobile object group approaching the mobile object from among a plurality of mobile object groups each belonging to a plurality of clusters obtained by the clustering, and identifies an area including a cluster to which the identified mobile object group belongs as the facing lane area.

4. The information processing device according to claim 1, wherein the processor estimates a first vanishing point from an edge of the lane area, estimates another mobile object farthest from the mobile object as a second vanishing point, and identifies the first vanishing point or the second vanishing point as vanishing points when a distance between the first vanishing point and the second vanishing point is within a threshold value.

5. The information processing device according to claim 1, wherein, when the processor determines that the mobile object is traveling on a curved road, the processor estimates the first vanishing point from an edge of the lane area, estimates another mobile object farthest from the mobile object as the second vanishing point, and identifies the first vanishing point or the second vanishing point as a vanishing point when a distance between the first vanishing point and the second vanishing point is within a threshold value.

6. The information processing device according to claim 5, wherein the processor determines that the mobile object is traveling on a curved road when determining that a segment point exists on the center line.

7. The information processing device according to claim 1, wherein the processor clusters one or more other mobile objects detected from the image data for a plurality of frames captured in time series.

8. The information processing device according to claim 1, wherein the processor clusters the other mobile objects based on the relative position of the other mobile objects in the lateral direction and a moving average of the relative movement amount of the other mobile objects in the longitudinal direction.

9. The information processing device according to claim 1, wherein the processor clusters only the other mobile objects that are four-wheeled vehicles.

10. The information processing device according to claim 1, wherein
the processor detects the other mobile object located behind the mobile object, and
the processor estimates a movement direction of the other mobile object based on the relative position of the other mobile object in the lateral direction and the relative movement amount of the other mobile object in the longitudinal direction, and
determines whether the other mobile object will overtake based on the estimated movement direction of the other mobile object and the lane area.

11. The information processing device according to claim 10, wherein the processor notifies a passenger of the mobile object of overtaking when it is determined that the other mobile object will overtake the mobile object.

12. An information processing method comprising:
detecting, by a computer, one or more other mobile objects from image data obtained by imaging an area around a mobile object;
calculating, by the computer, a relative position of the other mobile objects in a lateral direction of the mobile object and a relative movement amount of the other mobile objects in a longitudinal direction of the mobile object, with the mobile object as a reference;
clustering, by the computer, the other mobile objects based on the relative position of the other mobile objects in the lateral direction and the relative movement amount of the other mobile objects in the longitudinal direction;
identifying, by the computer, a lane area based on a result of the clustering; and
estimating, by the computer, a center line of a lane on which the mobile object is traveling, based on the lane area.

13. A computer-readable non-transitory storage medium storing a program that causes a computer to:
detect one or more other mobile objects from image data obtained by imaging an area around a mobile object,
calculate a relative position of the other mobile objects in a lateral direction of the mobile object and a relative movement amount of the other mobile objects in a longitudinal direction of the mobile object, with the mobile object as a reference;
cluster the other mobile objects based on the relative position of the other mobile objects in the lateral direction and the relative movement amount of the other mobile objects in the longitudinal direction,
identify a lane area based on a result of the clustering, and
estimate a center line of a lane on which the mobile object is traveling, based on the lane area.
